(19) United States
(12) Patent Application Publication
(10) Pub. No.: US 2005/0253545 A1
(43) Pub. Date: Nov. 17, 2005

(54) Method of starting an electronically commutated motor

(75) Inventor: Konstantin Dornhof, Immendingen (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: ebm-papst St. Georgen GmbH & Co. KG

(21) Appl. No.: 11/127,872

(22) Filed: May 11, 2005

(30) Foreign Application Priority Data
May 12, 2004 (DE) 10 2004 024 638.6

(51) Int. Cl. H02P 7/00

(52) U.S. Cl. 318/434; 318/778

(57) ABSTRACT

An electronically commutated motor (ECM) often employs a Hall sensor for reliable operation. Even when a Hall sensor is omitted from a motor structure, one can assure reliable startup, in a preferred rotation direction, if the motor (20) is designed with an auxiliary reluctance torque (Tᵣₑₗ) which, when the motor is running in the preferred rotation direction (DIR=1), has a driving branch (130) that is effective where a gap (136) exists in an electromagnetic torque (Tₑₗ) between two successive driving portions of that electromagnetic torque (Tₑₗ), and by using the steps of (a) upon starting, controlling application of electrical energy to the motor (20) in such a way that, in the event of a start in the wrong rotation direction, the motor cannot overcome the braking reluctance torque (130′) which is then effective; and (b) monitoring rotor movement to determine whether the rotor (22) is rotating in the desired rotation direction (DIR=1).

### CROSS-REFERENCES

This application incorporates by reference the Müller patents, U.S. Pat. No. 4,119,895 and corresponding DE 23 46 380-C2. This application claims priority from German application DE 10 2004 024 638.6, filed 12 May 2004, the entire content of which is incorporated by reference.

### FIELD OF THE INVENTION

The invention relates to a starting method for an electronically commutated motor (ECM) that, prior to starting, is rotated into a predefined rest position by a reluctance torque built into the motor, as is the case, for example, in fans that are driven by such motors.

### BACKGROUND

Motors of this kind usually use a rotor position sensor, for example a Hall sensor, to ensure starting in the desired rotation direction. A Hall sensor of this kind requires precise mechanical placement, which is difficult especially with small motors. The permissible maximum temperature of a Hall sensor is also limited, and problems can result when it is used in an aggressive atmosphere. It is also often desirable for the electronics to be at a distance from the motor, e.g. for applications in an environment where explosion protection is necessary.

The so-called “sensorless” principle is therefore utilized in such cases, in order to enable dependable starting of the motor in the correct rotation direction. Once the motor has started, continued operation in the desired rotation direction does not constitute a problem.

### SUMMARY OF THE INVENTION

It is therefore an object of the invention to provide a new starting method and a corresponding motor structure, in which reliable operation is achieved, even in the absence of a Hall sensor.

According to the invention, this object is achieved by controlling electrical energy applied to the motor so that, if it tries to start in the non-preferred direction, the motor cannot overcome a braking portion of auxiliary reluctance torque, and monitoring rotor movement to detect whether the rotor is rotating in the desired rotation direction. The result thereof is that the motor reliably starts up in the desired direction.

Further details and advantageous refinements of the invention are evident from the exemplary embodiments, in no way to be understood as a limitation of the invention, that are described below and shown in the drawings.

### BRIEF FIGURE DESCRIPTION

FIG. 1 is a circuit diagram of a motor adapted for carrying out a method according to the present invention;

FIG. 2 is an overview diagram to illustrate a method according to the present invention;

FIG. 3 depicts the torques that occur during operation, in a motor according to the invention, when that motor is rotating in the desired rotation direction;

FIG. 4 is similar to FIG. 3, but depicts the torques for the case in which the rotor is not rotating in the desired rotation direction;

FIG. 5 is a flow chart to explain a preferred method sequence;

FIG. 6 depicts the currents that can occur upon starting;

FIG. 7 is a depiction similar to FIG. 6, in which the current through the motor is lower after starting than during starting;

FIG. 8 shows the profile of the induced voltage during operation of the motor in its preferred rotation direction;

FIG. 9 shows the profile of the induced voltage during operation of the motor opposite to its preferred rotation direction;

FIG. 10 is a basic circuit diagram to explain the considerations underlying “sensorless” sensing of the rotation direction in a motor of this design;

FIG. 11 schematically depicts sensing of the rotation direction for DIR=1; and

FIG. 12 schematically depicts sensing of the rotation direction for DIR=0.

### DETAILED DESCRIPTION

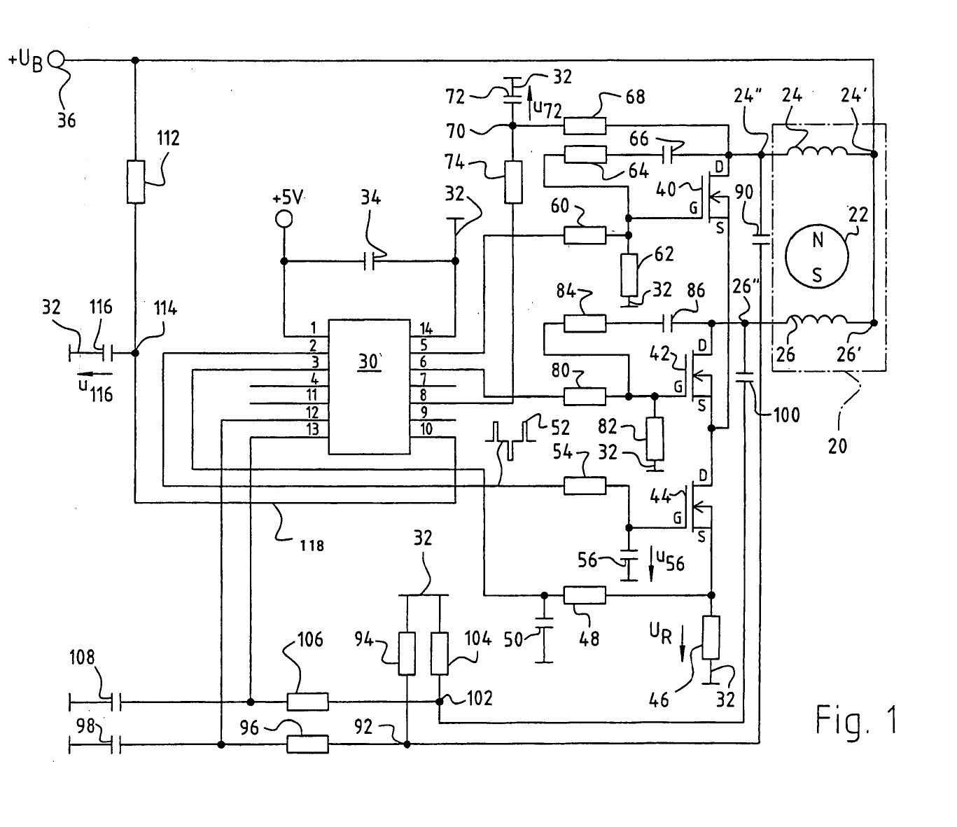

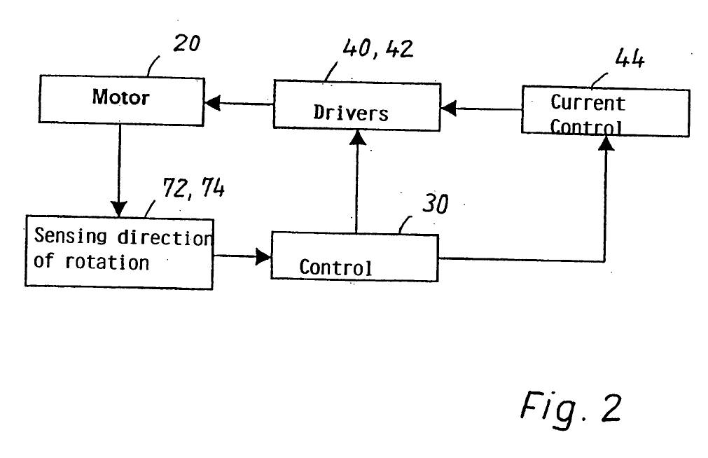

FIG. 1 illustrates a circuit for operating a so-called “two-pulse” electronically commutated motor 20 (ECM) that has a permanent-magnet rotor 22 and a stator winding, the latter being shown here with two phases 24, 26 that are usually magnetically coupled to one another, via the iron of the stator lamination stack (not shown). A motor of this kind is called “two-pulse” because two stator current pulses flow in stator winding 24, 26 for each rotor rotation of 360° el. In many cases, the stator winding can have only one phase, and then a current pulse flows in it in one direction during one rotation of 180° el., and a current pulse flows in the opposite direction during the subsequent rotation of 180° el. There are many designs for these motors, which are produced in enormous quantities. A typical example is shown in Müller DE 23 46 380 C2 and corresponding U.S. Pat. No. 4,119,895. Such motors are often implemented as so-called “claw pole motors,” the claw poles then being implemented so that they generate a reluctance torque dependent on the rotational position.

Most motors of this kind use a Hall sensor to sense the rotor position. When it is necessary to produce such motors for an extended temperature range, however, or when a considerable distance exists between ECM 20 and its electronic controller, the rotor position must be sensed using the so-called “sensorless” principle.

FIG. 1 refers to a circuit based on the sensorless principle, i.e. having no Hall sensor. Rotor 22 is depicted with two poles, but can also have different numbers of poles. In a two-pole rotor, one complete revolution corresponds to a rotation through 360° electrical, i.e. in this case
360° mech.=360° el. (1).
For a four-pole rotor:
360° mech.=720° el.
These relationships are familiar to those of ordinary skill in the art of electrical engineering.

Motor 20 is controlled by a microcontroller (μC) 30 whose terminals are labeled 1 through 14. These refer to a μC of the PIC16F676 type, details of which are available at the website WWW.MICROCHIP.COM maintained by Microchip Technology Inc. of Chandler, Ariz., USA. Terminal 1 is connected to a regulated voltage of +5 V, and terminal 14 to ground 32. A capacitor 34 is connected between terminals 1 and 14.

Motor 20 is supplied with power by an operating voltage U_{B}. The positive terminal is labeled 36, and the first terminals 24′, 26′ of phases 24, 26 are connected to terminal 36, as shown. Present between positive terminal 36 and ground 32 is, for example, a potential difference U_{B}=13 V, i.e. the voltage of a typical vehicle battery (not shown).

An n-channel MOSFET (Metal Oxide Field Effect Transistor) 40 serves to control the current in phase 24, and an n-channel MOSFET 42 serves to control phase 26. For that purpose, terminal 24″ of phase 24 is connected to drain terminal D of transistor 40, and terminal 26″ of phase 26 to terminal D of transistor 42. The source terminals S of the two transistors are connected to one another and to drain D of an n-channel MOSFET 44 which serves to generate a constant total current in phases 24, 26. Source S of transistor 44 is connected to ground 32 via a resistor 46 serving for current measurement. Voltage u_{R} at resistor 46 is delivered via an RC filter element 48, 50 to input 3 of μC 30. The μC furnishes, at its output 2, a control signal 52, corresponding to the magnitude of u_{R}, which controls the working point of transistor 44 so as to yield the desired constant current, which can be adjusted by the program of μC 30.

Inexpensive controllers, such as those used in motors, usually have no hardware to generate a PWM (Pulse Width Modulation) signal. Such a signal would therefore need to be generated by a program, which would consume most of the resources of such a microcontroller.

In this case, therefore, capacitor 56 is first charged through resistor 54. As a result, transistor 44 operates so as to yield the desired constant current, and that current is consequently adjustable by the program of μC 30. When capacitor 56 is charged, the terminal of μC 30 is switched to high resistance. When capacitor 56 discharges, its charge is “refreshed.” μC 30 usually requires only one clock cycle for this, i.e. 1 microsecond for the microcontroller indicated.

Transistors 40, 42 are each driven by control transistor 44, in the source region, in such a way that the current through phases 24, 26 is substantially constant, at least during commutation. Transistors 40, 42 are operated, for that purpose, as so-called “pinch-off” current sources. When transistor 40 is made conductive, for example, control transistor 44 acts as a resistor with respect to ground 32. The current intensity through phase 24, 26, and therefore the rotation speed of motor 20, can therefore be set by means of signal 52, and thus the voltage u₅₆ at capacitor 56.

The result of control transistor 44 is that the drain-source voltage U_{DS} in transistors 40 and 42 is modified, and the magnitude of the current through phases 24 and 26 is therefore also influenced. Another possible result of this is that transistors 40, operate in the pinch-off range. All types of field-effect transistors exhibit a pinch-off range of this kind.

When control transistor 44 is driven in such a way that it exhibits a high resistance, and therefore low conductivity, the potential at source S of the respectively conductive output-stage transistor 40, 42 then rises. As a result, less current flows through that transistor and it transitions into the pinch-off range.

When control transistor 48 is driven in such a way that it has a low resistance and therefore high conductivity, the potential present at source S of the respectively conductive transistor 40 or 42 is therefore low. The high gate-source voltage associated therewith results in a correspondingly high current intensity in phases 24, 26.

In contrast to an ordinary commutation operation, the current in motor 20 is thus kept substantially constant, with the results that motor 20 runs very quietly, and the starting of motor 20 can be controlled.

Transistor 40 is controlled by output 5 of μC 30, and transistor 42 by output 6. For that purpose, output 5 is connected via a resistor 60 to gate G of transistor 40, which is connected via a resistor 62 to ground 32 and via the series circuit of a resistor 64 and a capacitor 66 to drain D. The latter is connected via a resistor 68 to a node 70, which is connected via a capacitor 72 to ground 32 and via a resistor 74 to terminal 8 of μC 30. (Terminals 4, 7, 9, and 11 of μC 30 are not connected.)

During operation, a voltage u₇₂ that is used to determine the rotation direction of rotor 22 occurs at capacitor 72. This will be described below.

Output 6 is connected via a resistor 80 to gate G of transistor 42, which is connected via a resistor 82 to ground 32 and via the series circuit of a resistor 84 and a capacitor 86 to drain D.

Terminal 24″ is connected via a capacitor 90 to a node 92, which is connected via a resistor 94 to ground 32 and via a resistor 96 to input 12 of μC 30, to which a filter capacitor 98 is also connected.

Terminal 26″ is connected via a capacitor 100 to a node 102, which is connected via a resistor 104 to ground 32 and via a resistor 106 to input 13 of μC 30, to which a filter capacitor 108 is also connected.

Elements 90 through 108 cause the point in time during a rotor rotation at which the current through phase 24 or 26 is switched on to be shifted to an earlier point in time with increasing rotation speed; borrowing from the terminology of a gasoline engine, this is usually referred to as “ignition advance,” even though of course nothing is being “ignited” in an electric motor 20.

Connected to terminal 36 via a resistor 112 is a node 114 that is connected via a capacitor 116 to ground 32. A voltage u₁₁₆ dependent on the voltage at terminal 36 occurs during operation at capacitor 116, and this voltage is delivered via a line 118 to input 10 of μC 30 and serves to eliminate, by computation, noise voltages that are contained in voltage u₇₂. This will be described below.

PREFERRED VALUES OF COMPONENTS IN FIG. 1 (for U_{B} = 13 V)

| | |
|---|---|
| Transistors 40, 42, 44 | ILRL3410 |
| C72, 116 | 2 nF |
| C50, 66, 86, 98, 108 | 1 nF |
| C34, 56 | 100 nF |
| R62, 68, 82, 94, 96, 104, 106, 112 | 100 kilohm |
| R48, 54, 60, 80 | 10 kilohm |
| R74 | 0 ohm |
| R46 | 1.5 ohm |
| R64, 84 | 1 kilohm |

Motor 20 has a rotation direction sensing system 72, 74 with which a determination can be made as to whether the motor, after a startup attempt, is rotating in the desired rotation direction. Motor 20 furthermore has a control system, namely μC 30, with which current regulator 44 can be set to a desired starting current; this current regulator 44 acts on output stages 40, 42, as described above, in such a way that motor 20 can be operated with a constant starting current that is adjusted precisely in accordance with requirements.

Rotation direction sensing system 72, 74 allows a start in the wrong rotation direction to be detected and reported to control system 30. The latter then stops motor 20 and makes another attempt to start in the correct direction.

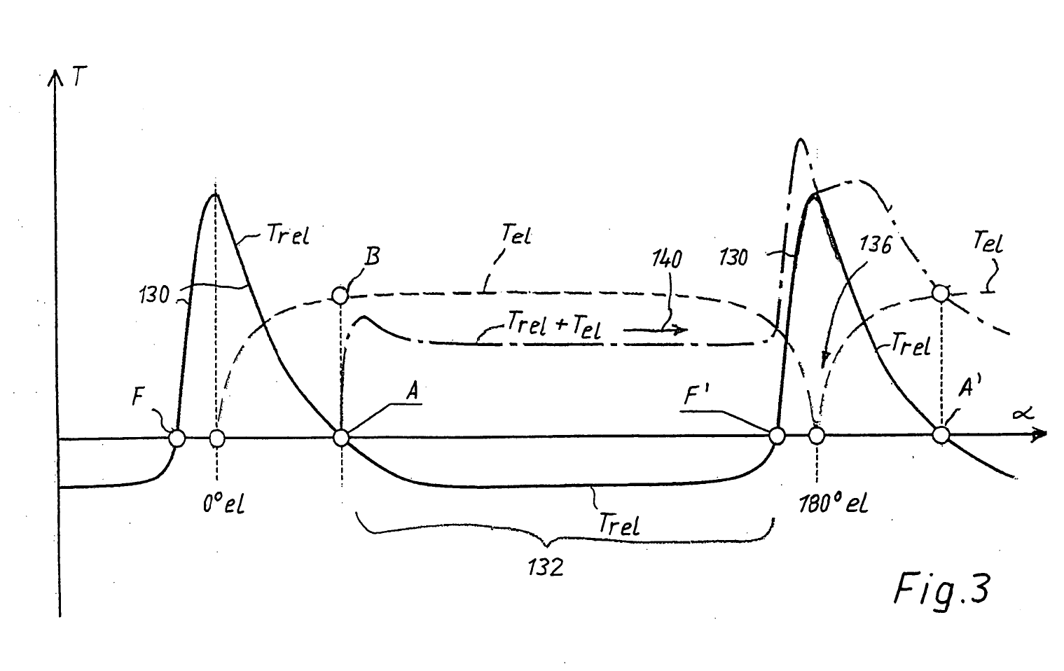

FIG. 3 shows the torques T that occur over the rotation angle alpha (α) of rotor 22 in a two-pulse motor 20 upon starting.

A motor of this kind has a reluctance torque Tᵣₑₗ that is, so to speak, “built into” the motor and is therefore invariant. This torque has, for the rotation direction depicted in FIG. 3, a driving positive portion or branch 130 that is relatively short and has a high amplitude. Tᵣₑₗ additionally has a negative (i.e. braking) portion or branch 132 that has a low amplitude, but a longer duration.

When rotor 22 is driven externally, it is braked between points A and F′ by negative branch 132 of reluctance torque Tᵣₑₗ. Between points F′ and A′, Tᵣₑₗ becomes positive and thereby assists the rotation of rotor 22 in the desired rotation direction.

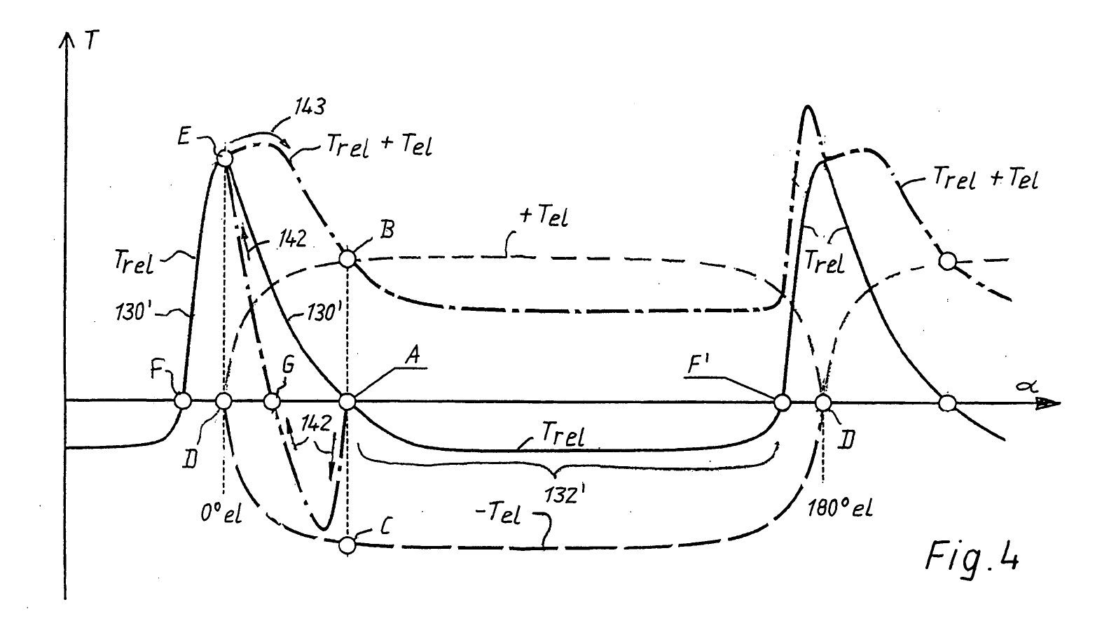

When rotor 22 is driven in the opposite direction, as shown in FIG. 4, i.e. from A to F in FIG. 4, branch 130′ of Tᵣₑₗ then has a strongly braking effect between points A and F, and branch 132′ has a driving effect. The conditions are thus the reverse of those in FIG. 3.

Also plotted in FIG. 3 is the electromagnetic torque Tₑₗ that, for the rotation direction according to FIG. 3, has a driving effect in the manner depicted and thus overcomes negative branch 132 of Tᵣₑₗ. Electromagnetic torque Tₑₗ has, as shown, gaps 136 that are bridged by positive branch 130 of Tᵣₑₗ, as is directly evident from FIG. 3. The resultant torque Tᵣₑₗ+Tₑₗ is consistently positive, and causes motor 20 to be driven continuously in the preferred direction, i.e. DIR=1.

FIG. 4 shows the electromagnetic torque −Tₑₗ during operation in the opposite rotation direction. In this case, it is assisted by branch 132′ of Tᵣₑₗ, while it is counteracted by branch 130′ (which is braking in this case) of Tᵣₑₗ.

A motor 20 of this kind thus has a preferred direction that is depicted in FIG. 3, in which torques Tₑₗ and Tᵣₑₗ complement one another very effectively; and it has a “bad” rotation direction shown in FIG. 4, in which torques Tₑₗ and Tᵣₑₗ coordinate very badly with one another, so that startup in this rotation direction is difficult. Startup in this rotation direction is not usually required.

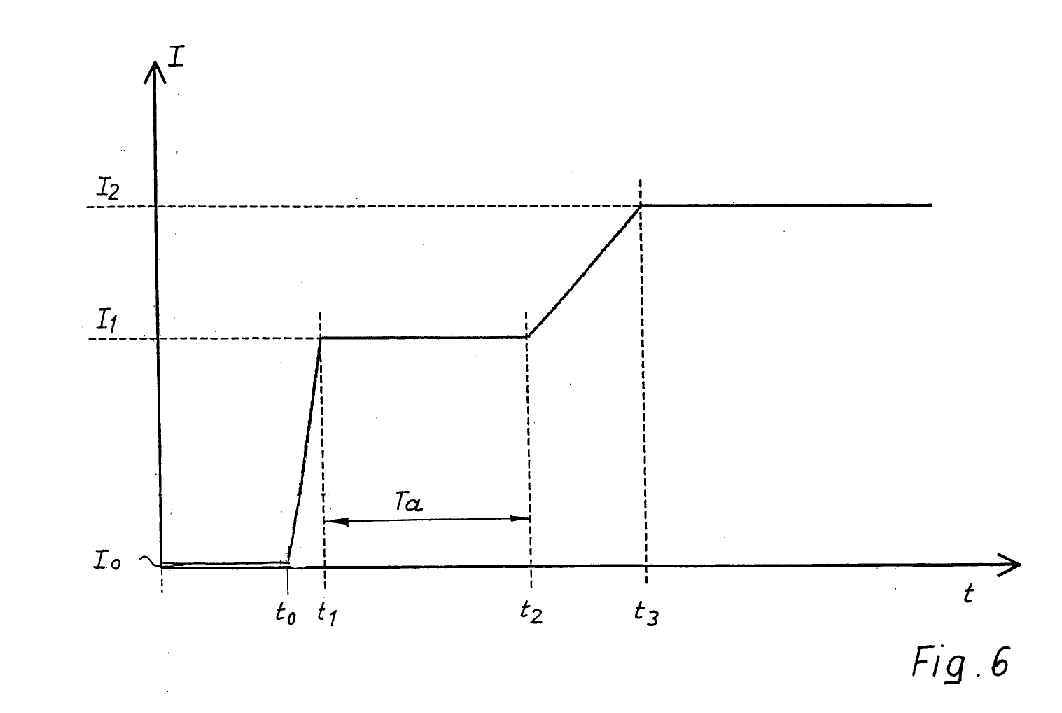

As shown in FIG. 6, in order to start in the rotation direction depicted in FIG. 3, the constant current I in the motor is set to a value I1 , the rise in the current from I=0 to I=I1 occurring substantially monotonically and within a short period.

At starting, rotor 22 is usually in position A (FIG. 3), because Tᵣₑₗ has a value of zero there and it is a stable rest position of rotor 22.

When rotor 22 starts from this rest position A in the correct rotation direction, the electromagnetic torque Tₑₗ, which previously had a value of zero, then rises to point B (FIG. 3), becomes greater than the braking branch 132 of Tᵣₑₗ, and drives rotor 22 against braking branch 132 of Tᵣₑₗ so that rotor 22 rotates in the direction of arrow 140 (FIG. 3)

Additional confirming actions would be superfluous in the context of startup in the preferred direction, but such actions are preferably performed in both rotation directions, so that the structure of the program used can be kept simple.

As shown in FIG. 6, current I1 is maintained for a time period Ta, i.e. between times t1 and t2; Ta can be, for example, between 0.5 and 2 seconds depending on the size of the motor.

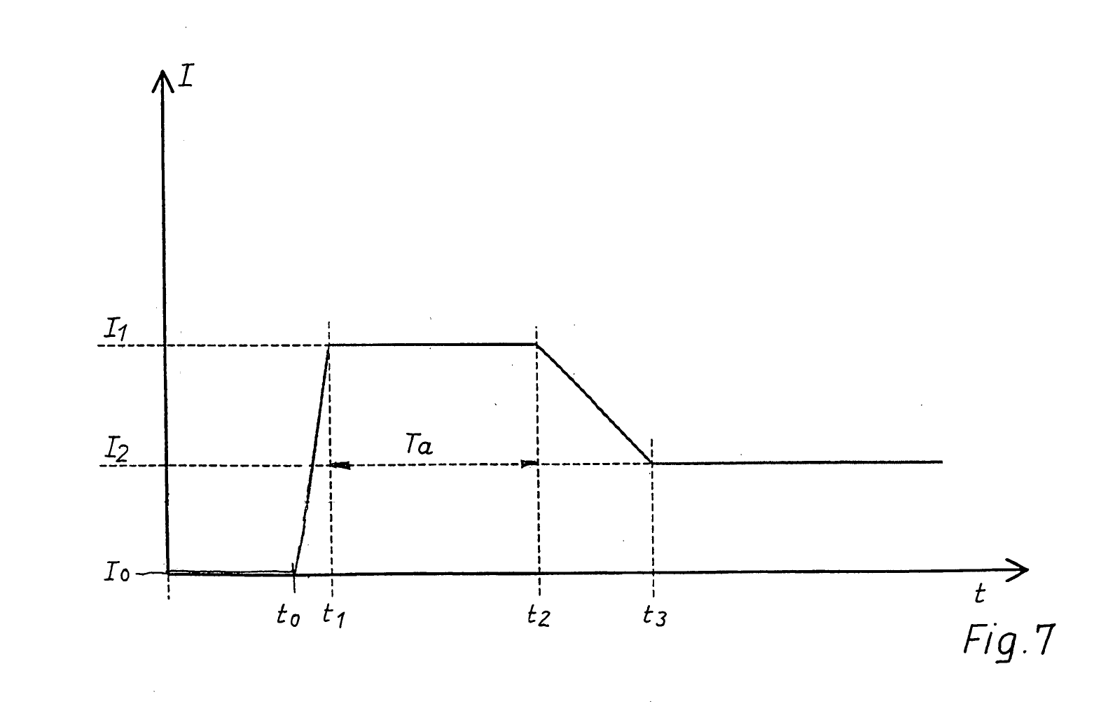

When motor 20 is then running normally, current regulator 44 sets current I to a value I2 that corresponds to the desired rotation speed of motor 20. FIG. 6 shows the case in which I2 is greater than I1. FIG. 7 shows the opposite case, in which I2 is less than I1. It is apparent, from this, that I1 and time period Ta should be selected in accordance with the requirements for motor starting.

FIG. 4 shows what happens if rotor 22 starts in the wrong direction. In this case, current I1 generates a torque −Tₑₗ in the opposite direction, so that this electromagnetic torque −Tₑₗ drives rotor 22 in the direction of arrows 142 (FIG. 4), in which context −Tₑₗ decreases in magnitude. A resultant total torque Tₑₗ+Tᵣₑₗ is initially negative, and causes a small rotation opposite to the preferred direction. After passing through a point G, the resultant total torque Tₑₗ+Tᵣₑₗ becomes positive, so that the rotation comes to a stop at point E.

The profile and amplitude of −Tₑₗ are determined by the constant current I1. The latter is defined so that torque −Tₑₗ cannot overcome branch 130′ (which is braking in this case) of reluctance torque Tᵣₑₗ in the event of startup in the wrong rotation direction; in other words, rotor 22 starts from a point C and arrives at a point D. At point D a commutation occurs, i.e. the current is switched over either from phase 24 to phase 26 or vice versa. The result is that the direction of the electromagnetic torque is switched over to +Tₑₗ, and a positive total torque (Tₑₗ+Tᵣₑₗ) is produced which causes a rotation in the preferred direction, as indicated by an arrow 143.

The program of μC 30 contains the corresponding routines for this purpose.

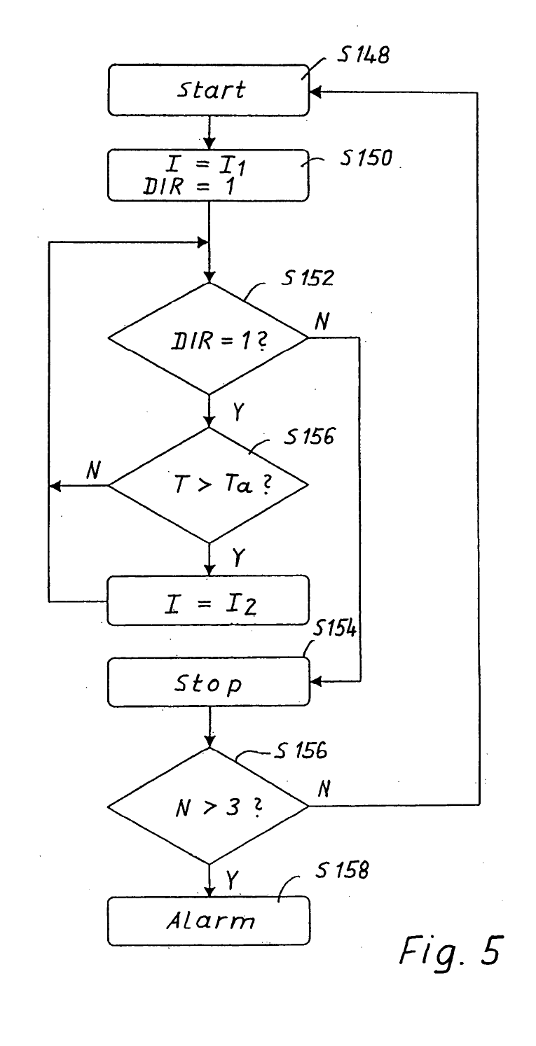

FIG. 5 is the corresponding flow chart, which begins at S148. At S150 the rotation direction is set to DIR=1, and current regulator 44 is set to I=I1. The profile and duration of the ramp-up between values I=0 and I=I1 can also be set.

S152 checks whether rotor 22 is, in fact, rotating in rotation DIR=1, i.e. whether a corresponding rotation direction signal is present. If NO, the program goes to S154 and motor 20 is switched off.

If DIR=1 in S152, S156 then checks whether the time period Ta, e.g. one second, has already elapsed. If NO, energization with I1 continues. If time period Ta has elapsed, the constant current is switched over to I2 (see FIG. 6 and FIG. 7).

Following S154, the program goes to S156, where the number N of starting attempts is counted. If this number is greater than 3, the program goes to S158 and generates an alarm. If N is less than 4 in S156, a new attempt is made to start in the correct rotation direction.

Ascertaining the Rotation Direction

The rotation direction is ascertained by sensing and analyzing the voltages induced in the stator winding during operation. This is possible because, in a motor of the kind cited initially, these voltages have different profiles, depending on the rotation direction. From this, the desired information, regarding the rotation direction of the motor relative to the reluctance torque, can be derived.

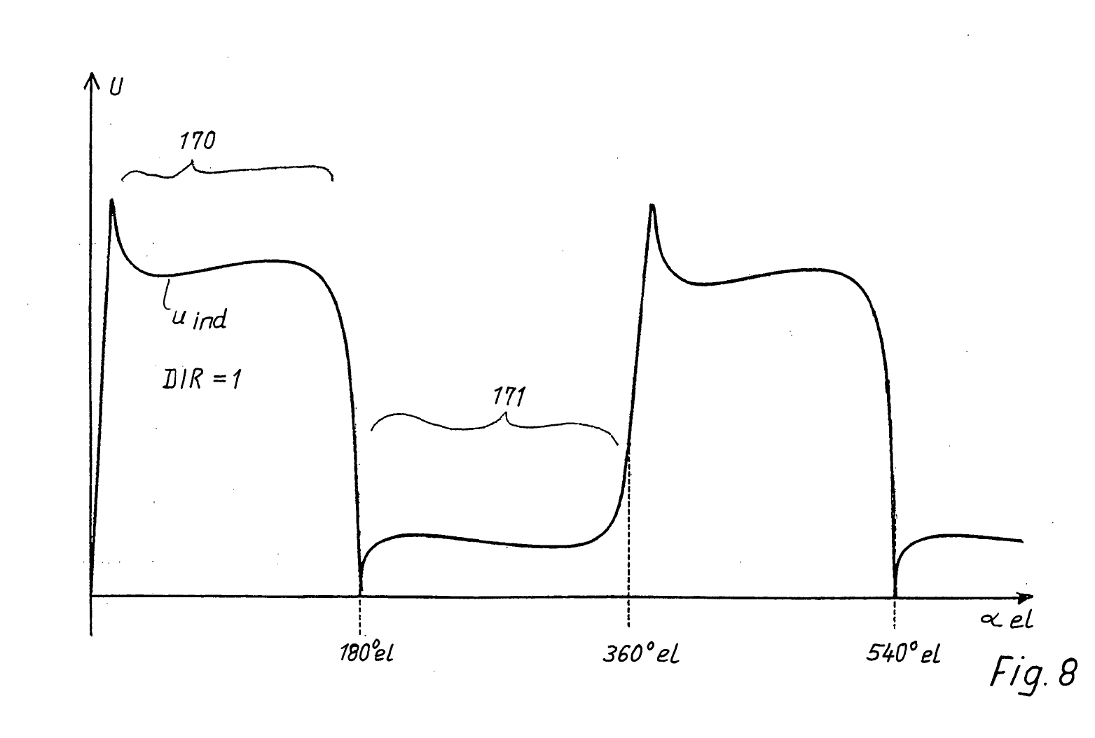

FIG. 8 shows the profile of the induced voltage u_{ind} during operation of motor 20 in its preferred rotation direction (DIR=1). It is apparent that the induced voltage u_{ind} shows a rising trend over a large rotation angle range 170 when the relevant phase is currentless. In rotation angle range 171 in which a current is flowing in the relevant phase, the voltage is lower and shows a decreasing trend.

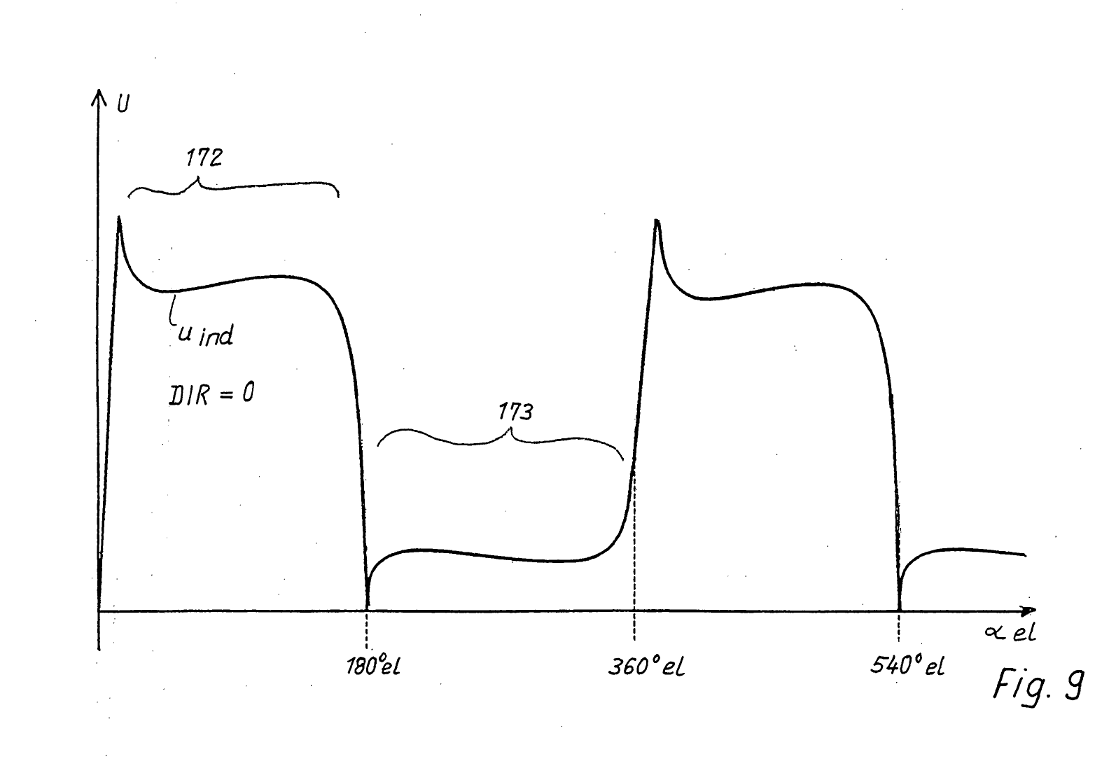

FIG. 9 shows, for comparison, the induced voltage u_{ind} during operation of motor 20 opposite to its preferred rotation direction (i.e. for DIR=0). It is apparent that the induced voltage decreases over a large rotation angle range 172 when the relevant phase is currentless. In rotation angle range 173 in which, for DIR=0, a current is flowing in the relevant phase, the voltage is lower and shows a rising trend.

It should be noted that FIGS. 8 and 9 are schematic depictions; in other words, the rise in ranges 170 and 173 and the decrease in ranges 171 and 172 may in reality be less pronounced. The differences are shown in exaggerated fashion, for didactic purposes.

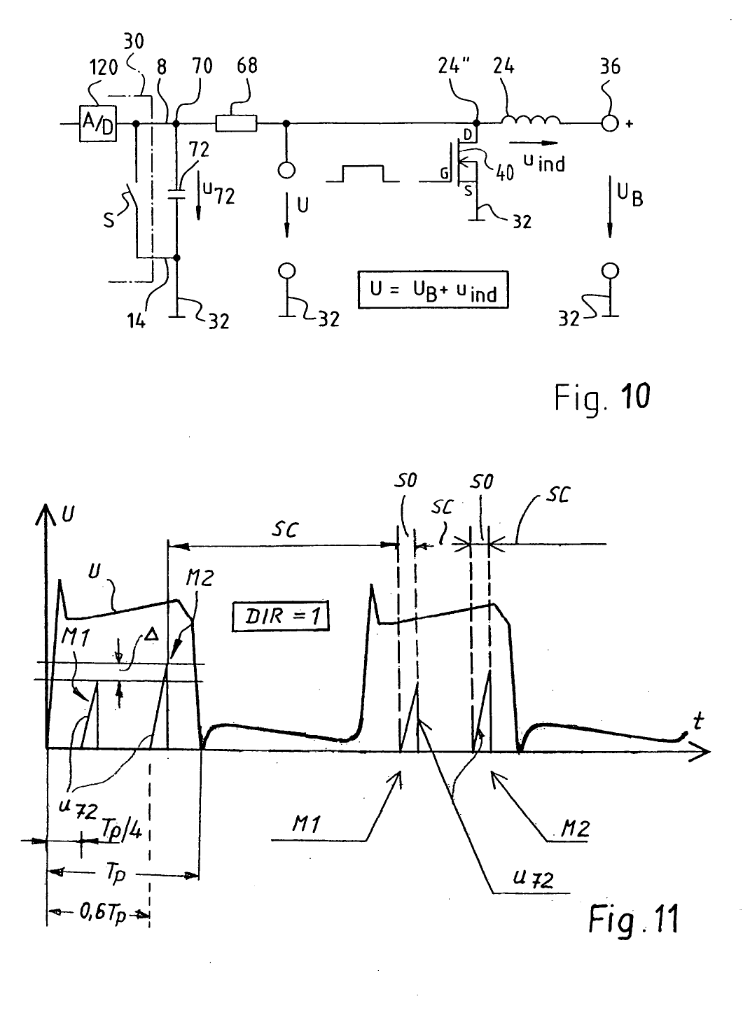

FIG. 10 shows a portion of FIG. 1, namely those elements of the measurement circuit that are essential for sensing the rotation direction.

The potential at point 24″ of phase 24 is measured when transistor 40 is not conductive, i.e. when transistor 42 is carrying current. In this case, operating voltage U_{B} is present at point 36, and added to this is the induced voltage u_{ind} in currentless phase 24, so that the potential U at point 24″ is
U=U_{B}+u_{ind} (2).

This potential is delivered through resistor 68 to capacitor 72.

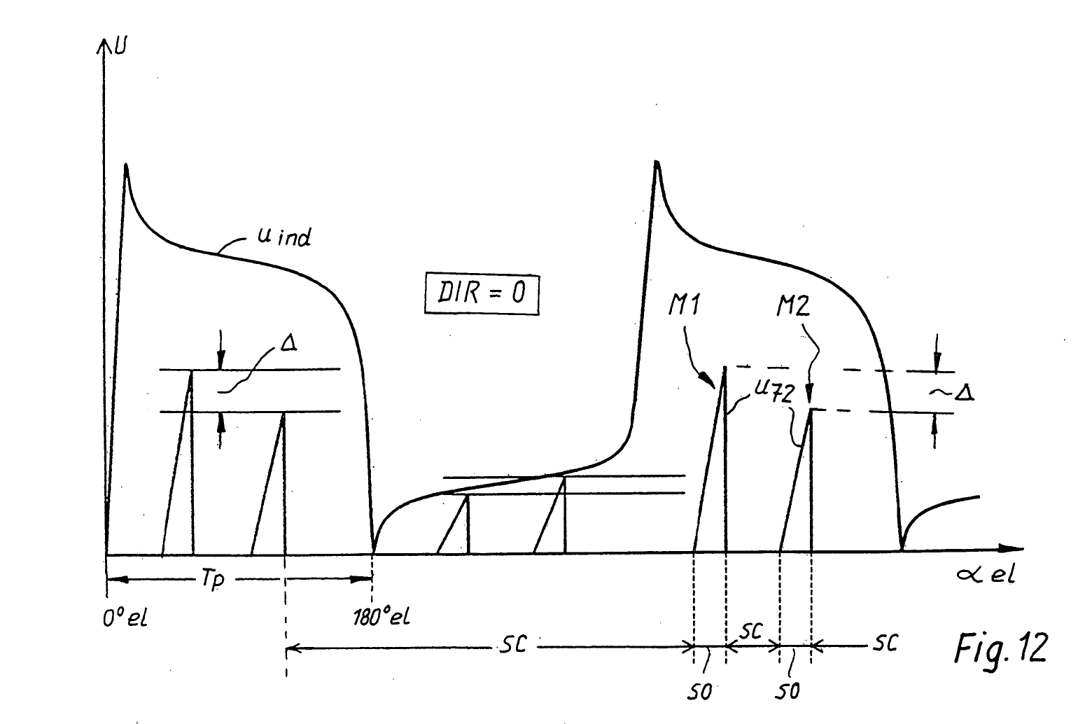

Located in parallel with capacitor 72 is a switch S in μC 30; this switch S is closed most of the time—symbolized in FIGS. 11 and 12 by “SC” (=switch closed)—thus keeping capacitor 72 discharged so that during this time, voltage u₇₂ has a value of zero.

When a measurement M is to be performed, switch S is opened by the program of μC 30 so that the voltage u₇₂ at capacitor 72 rises to a value corresponding approximately to the instantaneous voltage U. This voltage at capacitor 72 is converted in A/D converter 120 into a digital value and temporarily stored.

If the time interval between two commutations is designated Tp, this happens once, for example, after a time Tp/4, and at this point in time a first measurement M1 is performed and a first value u_72.1 is stored.

After a predetermined time period, e.g. after 0.5-0.6 Tp, a second measurement M2 is then performed and the second value u_72.2 measured at that point is also stored.

The difference Δ is then calculated, i.e.:
Δ=u_72.2−u_72.1 (3),
and the sign of the difference Δ is determined.

In FIG. 11, the difference Δ is found to have a positive sign and, in FIG. 12, the sign is negative, since in the case of the rotation direction according to FIG. 12 the voltage U has a decreasing characteristic (as in FIG. 9) in the currentless phase, whereas in FIG. 11 it has a rising characteristic (as in FIG. 8). This is a property of these two-pulse motors that is exploited in the present case, in order to sense the rotation direction.

It is very advantageous in this context that the current in resistor 46 is kept constant by control transistor 44, i.e. phase 26 that is presently conducting current has substantially no influence on the voltage u_{ind} in phase 24, in which the measurements are taking place, since the constant current in phase 26 causes no transformer coupling to phase 24.

Because motor 20 is running in DIR=1 after starting up correctly, FIG. 11 shows that a positive Δ is obtained as confirmation of a correct startup.

If motor 20 is rotating in direction DIR=0 after starting, a negative Δ is obtained as shown in FIG. 12; starting is interrupted and a new starting attempt is made. This ensures that the motor starts in the correct rotation direction in every instance.

The absolute measured values that are measured at the energized phase 24 or 26 are additionally used to generate a constant current. If u_{R} drops below 1 V, it becomes difficult to maintain a constant current.

A great advantage of the present invention that a Hall sensor is not necessary, and that reliable startup in the desired rotation direction is nevertheless possible. ECMs (Electronically Commutated Motors) having a wider temperature range can thus be produced and, in an ECM of this kind, the motor can be physically separated from its control system.

Many variants and modifications are of course possible within the scope of the present invention.

1. A method of starting, in a preferred rotation direction, an electronically commutated motor (ECM) having
a stator with a stator winding arrangement (24, 26) and a permanent-magnet rotor (22), which rotor generates during its rotation, by interaction with the stator, an auxiliary reluctance torque (Tᵣₑₗ) having driving portions (130) and braking portions (132),
an apparatus for controlling the current in the stator winding arrangement (24, 26) in order to generate an electromagnetic torque (Tₑₗ) that having two driving portions for each rotor revolution of 360° el., adjacent driving portions being in each case separated by a gap (136), and, upon rotation of the rotor (22) in its preferred rotation direction (140), a driving portion (130) of the reluctance torque (Tᵣₑₗ) is effective in each case in a gap (136) between two driving portions of the electromagnetic torque (Tₑₗ),
comprising the steps of:
a) controlling application of electrical energy to the motor in such a way that, in case of a start in the direction opposite to the preferred rotation direction (142), the motor cannot overcome a braking portion (130′), effective in that opposite rotation direction, of the auxiliary reluctance torque (Tᵣₑₗ); and
b) monitoring rotor movement to determine whether the rotor (22) is rotating in the desired rotation direction.

2. The method according to claim 1, wherein said energy application controlling step comprises
limiting motor current to a predetermined value (I1).

3. The method according to claim 1, further comprising,
when said monitoring determines that the rotor (22) is not rotating in the desired rotation direction (DIR=1), the steps of
stopping the motor and making a new starting attempt.

4. The method according to claim 2, further comprising
setting a target constant value for motor current during startup; and
increasing motor current substantially monotonically to reach said target constant value.

5. The method according to claim 4,
further comprising maintaining said target constant value of current for a predetermined time period (Ta).

6. An electric motor comprising:
a stator having a stator winding arrangement (24, 26);
a permanent-magnet rotor (22) which, during its rotation, generates by interaction with the stator an auxiliary reluctance torque (Tᵣₑₗ) having driving portions (130) and braking portions (132);
an apparatus for controlling current in the stator winding arrangement (24, 26), in order to generate an electromagnetic torque having, for each rotor revolution of 360° el., two driving portions that are separated by a gap, and wherein, upon rotation of the rotor (22) in its preferred rotation direction, a driving portion (130) of the reluctance torque (Tᵣₑₗ) is effective in each case in the gap (136) between two driving portions of the electromagnetic torque (Tₑₗ), said motor operating by carrying out the steps of
a) controlling application of electrical energy to the stator winding arrangement (24, 26) in such a way that, in the event of a start in the rotation direction opposite to the preferred rotation direction, the motor cannot overcome a braking portion (130′), effective in that opposite direction, of the reluctance torque (Tᵣₑₗ); and
b) monitoring rotor movement to determine whether the rotor (22) is rotating in the desired rotation direction.

7. The motor according to claim 6,
wherein said controlling application of electrical energy is performed by a current limiting arrangement, in which a value for current limiting is adjustable.

8. The motor according to claim 7,
further comprising
a microcontroller (30),
a current measuring apparatus (46), and
a pinch-off current limiter (44),
and wherein a current limiting value of the pinch-off current limiter is controlled in accordance with an output signal (52) of the microcontroller (30).

9. The motor according to claim 8,
wherein the pinch-off current limiter comprises
a MOSFET (44) having a current limiting value which is a function of a charge voltage (u₅₆) of a capacitor (56) whose charge, in turn, is influenced by the microcontroller (30).
